(19) United States
(12) Patent Application Publication
(10) Pub. No.: US 2021/0170335 A1
(43) Pub. Date: Jun. 10, 2021

(54) METHOD AND TUBULAR MEMBRANE FOR PERFORMING A FORWARD OSMOSIS PROCESSING

(71) Applicant: BERGHOF MEMBRANE TECHNOLOGY GMBH, Leeuwarden (NL)

(72) Inventors: Kimball Sebastiaan ROELOFS, Eningen (DE); Gunther BISLE, Eningen (DE); Piotr Edward DLUGOLECKI, Leeuwarden (NL)

(73) Assignee: BERGHOF MEMBRANE TECHNOLOGY GMBH, Leeuwarden (NL)

(21) Appl. No.: 17/255,063

(22) PCT Filed: Jul. 5, 2019
(86) PCT No.: PCT/NL2019/050423

§ 371 Date: Dec. 22, 2020

(30) Foreign Application Priority Data
Jul. 6, 2018 (NL) 2021266
Nov. 13, 2018 (NL) 2021992

(51) Int. Cl. B01D 61/00; B01D 71/56

(52) U.S. Cl. CPC B01D 61/002; B32B 5/245; B01D 71/56

(57) ABSTRACT

A method for processing a fluid with forward osmosis process includes providing one or more tubular membranes each including a tubular nonwoven base layer on the outside of the tubular membrane forming an outer shell of the tubular membrane and providing a lumen for feed flow; a polymer substrate layer on the lumen-side of the tubular membrane comprising three regions, including a region where the polymer substrate layer is partially intruded into the tubular base layer, a region with an open macrovoid structure and a region with an asymmetrical foamy layer, where the partially intruded region forms an intermediate layer; and a functional top layer on the polymer substrate layer. The tubular base layer comprises a longitudinal weld. The method includes providing the feed flow through the lumen and providing a draw solution on the outer shell side of the tubular membrane; and processing the feed flow with the membrane.

The present invention relates to a method for processing a fluid with forward osmosis process.

Forward osmosis (FO) utilizes the osmotic pressure difference across a semi-permeable membrane separating two solutions with different solute concentrations. The osmotic pressure gradient is the driving force for permeation of water through the membrane. Water is transported through the membrane from the feed flow to a draw solution which has an high solute concentration relative to the feed flow. As a consequence, the feed solution in concentrated and the draw solution is diluted.

In practice the use of membranes is often subject to fouling: this is typically the case in pressure driven membrane processes when feed flows with relatively high solid content are filtered. Foulants and contaminants are pushed into and/or through the membrane. Fouling reduces the membrane performance and efficiency of the filtration process. Furthermore, intensive cleaning is required which results in reduced filtration output and shorter lifetime of the membrane module. In addition, energy consumption in pressure driven membrane processes is high, because on the one side a pressure has to be buildup and on the other side high volume flows are required to assure sufficient crossflow.

The invention is aimed at obviating or at least reducing the aforementioned problems and to provide an effective forward osmosis process.

This object is achieved with the method according to the invention for processing a fluid with forward osmosis process, the method comprising the steps of:
providing one or more tubular membranes, with the tubular membrane comprising:
   a tubular base layer of a nonwoven material on the outside of the tubular membrane and forming an outer shell of the tubular membrane and providing a lumen for the feed flow;
   a polymer substrate layer on the lumen-side of the tubular membrane comprising three regions, including a region where the polymer substrate layer is partially intruded into the tubular base layer, a region with an open macrovoid structure and a region with an asymmetrical foamy layer, wherein the partially intruded region forms an intermediate layer; and
   a functional top layer on the polymer substrate layer; and
wherein the tubular base layer comprises a longitudinal weld;
   providing the feed flow through the lumen and providing a draw solution on the outer shell side of the tubular membrane; and
   processing the feed flow with the membrane.

The forward osmosis filtration process utilizes the natural phenomenon osmosis to draw water from the feed flow through the membrane to the other side This process can be performed at relatively low hydraulic pressure compared to alternative pressure driven processes, such as reverse osmosis. Due to this relatively low pressure fouling of the membrane/membranes is minimal. Furthermore, energy required for the filtration process is significantly reduced. In addition, the filtration process can be advantageously used directly in low-pressure applications, including existing feed streams without having to increase the feed flow pressure.

According to the method of the invention one or more tubular membranes are provided. These membranes each form a lumen for the feed flow. Nonwoven tape is bent in axial direction over a mandrel (tube forming section) whereby the nonwoven overlap is welded to obtain a tubular nonwoven tube with a longitudinal weld. This is a continuous process where the tube is formed and moves continuously in axial direction. The tubular membrane comprises a tubular base layer of a nonwoven material on the outside of the tubular membrane therewith forming an outer shell. The nonwoven material provides mechanical stability of the membrane.

On the lumen-side of the nonwoven tube, a liquid polymer dope solution is continuously cast onto the inside of the tube followed by a continuous doctoring in order to obtain a homogeneously distributed layer on the inside of the tube. During casting and doctoring, the polymer dope solution also intrudes partially the nonwoven base layer. Subsequently, the membrane is formed by precipitation, generally by means of the phase inversion process, to obtain a porous polymer membrane structure partially in, but mainly on top of the nonwoven. The region where the substrate material is intruded into the nonwoven base layer provides additional stability and strength to the membrane. It furthermore provides an increased resistance against delamination of the substrate layer from the nonwoven base tube. The second region of the polymer substrate layer consists of a macrovoid structure, ideally finger shaped macrovoids. This results in low resistance to the net transport of water through the membrane. In addition, it reduces internal concentration polarization, i.e. due to accumulation of solute, such as salt, in the membrane that may reduce the driving force of the process. The third region of the polymer substrate layer is an asymmetrical foamy structured layer preferably with a thickness in the range of 5-10 μm. This accounts for a smooth, defect-free top region, making the substrate feasible for further coating.

A functional polymer top layer is provided on the lumen-side of the tubular membrane, for example by interfacial polymerization involving coating with materials that preferably react on the (inner) surface of the tubular membrane and/or layer-by-layer deposition involving polyelectrolytes. The functional polymer top layer allows a net transport of water through the membrane from the feed flow to a draw solution on the other side of the membrane and (substantially) retains the solute, such as salt ions. This top layer is important for having and for maintaining the driving force in the process.

As a further effect, flow resistances are low, thereby enabling a higher flow rate in combination with the relatively low energy usage.

The tubular membrane comprises a longitudinal weld, more specifically the tubular base layer comprises such longitudinal weld. Such longitudinal weld reduces the welding surface to a minimum as compared to spiral welds, for example. This reduction in welding surface increases the effective membrane surface. This increase may amount up to 10% of the membrane surface as compared to spiral weld membranes, for example.

A further advantageous effect is the possibility for easy manufacturing of a tubular membrane with a longitudinal weld. The required manufacturing time for a tubular membrane according to the invention can be decreased, thereby reducing manufacturing costs. This contributes to a reduction in filtration costs, for example.

An advantage of performing a forward osmosis filtration with one or more tubular membranes is that the hydraulic pressure is relatively low. Also the shear forces working on the membranes are relatively low, because low linear velocity of the liquids (feed and draw) is required. This enables the use of nonwoven material with a relatively small thickness.

The method of the invention is advantageously applied to feed flows with a relatively high solid content (high TSS, such as above 10 g/L, and/or viscosity). Examples of feed flows that can be effectively filtered with the method of the invention are a milk flow, including cow milk, goat milk and coconut milk. The forward osmosis process reduces the amount of water in the milk flow such that transport can be done more effective and efficiently. Other examples are whey, juice, sugar, algae, recovery of harmful metals in semiconductor industry, high salinity waste, including landfill leachate and hazardous and/or harmful waste.

A further advantage of the forward osmosis process is the better rejection compared to other filtration processes, since chemical substances, e.g. contaminants are not pushed through the membrane by hydraulic pressure.

The configuration with the feed flow in the lumen is referred to a functional layer facing feed solution, to which is also referred as active layer facing feed solution (ALFS) or FO-mode. Especially when handling feed flows with high TSS and/or viscosity this enables better cleaning, for example by increasing the crossflow, and pressurization of the tube.

In a further preferred embodiment of the invention the method comprises the step of cleaning the membrane in a cleaning step comprising a reversal of flows and/or an increased crossflow velocity and/or an osmotic backwash.

Cleaning of the membrane and more specifically the membrane surface is preferably periodically applied, for example by increasing crossflow velocity and/or varying crossflow velocity and/or an osmotic backwash. This effectively cleans the membrane surface and maintains the filtration performance.

In a further preferred embodiment of the invention hydraulic pressure to the feed flow is provided with a pressure in the range of 0-4 bar, preferably in the range of 0-2 bar, and most preferably in the range of 0-1 bar. The hydraulic pressure on the feed side preferably exceeds the pressure on the draw side, therefore avoiding implosion of the tubular membrane, therewith avoiding implosion of the tubular membrane.

Providing a pressurized feed flow may improve process performance. For example, a pressurized feed flow may enable a pressure assisted forward osmosis process. The present invention also relates to a tubular membrane configured for a forward osmosis process, the tubular membrane comprises:
a tubular base layer of a nonwoven material on the outside of the tubular membrane and forming an outer shell of the tubular membrane and providing a lumen for the feed flow;
a polymer substrate layer on the lumen-side of the tubular membrane comprising three regions, including a region where the polymer substrate layer is partially intruded into the tubular base layer, a region with an open macrovoid structure and a region with an asymmetrical foamy layer, wherein the partially intruded region forms an intermediate layer; and
a functional top layer on the polymer substrate layer; and
wherein the tubular base layer comprises a longitudinal weld;

The tubular membrane provides the same or similar effects or advantages as described in relation to the method. These advantages include low manufacturing costs, enabling effective forward osmosis filtration. In addition, providing a longitudinal weld limits the introduction of forces and stresses in the nonwoven material during production. More specifically, these forces and stresses are limited as compared to spiral weld tubular membranes, for example. It will be understood that material properties and characteristics are relevant for (embodiments) of the tubular membrane and also for the aforementioned method according to the invention.

In a further preferred embodiment of the invention the functional polymer membrane layer comprises a polyamide or a polyamide-based layer as a coating layer on the polymer substrate layer. The water flux over the top layer, and the tubular membrane, is preferably above 5 L/m²/h (also defined as LMH), and a reverse salt flux below 3 g/m²/h (also defined as gMH), wherein the water flux and the reverse salt flux are preferably measured with about 1 M NaCl concentration difference at around 20° C., which are ‘standard conditions’ for performing such measurements. This can be achieved with the tubular membrane of the present invention.

Experiments have shown that the use of polyamide or a polyamide-based layer as a coating layer provides an effective membrane.

Preferably, the substrate material comprises one or more of polyethersulfone (PES), polysulfone (PSf), polyphenylsulfone (PPSU), polyvinylidende fluoride (PVDF), polyamide (PA), polyacrilnitril (PAN) and combinations thereof. Preferably, the molecular weight cut off of the polymer substrate layer is in the range of 5-20 kDa when determined with polyethylene glycol (PEG) under crossflow conditions of 4 m/s, a transmembrane pressure (also defined as TMP) of 1 bar, a temperature of 20° C.

In a preferred embodiment of the invention, the foamy asymmetrical layer of the polymer substrate layer is integrally formed, and wherein the foamy asymmetrical layer is formed on top of the macrovoid-structured layer, that is provided with a substantial amount of macrovoids, the macrovoids having a length that substantially extends in a radial direction of the tubular membrane.

It is preferred that the polymer substrate layer, and preferably specifically the foamy layer and the macrovoid structured layer, have a substantial amount of holes with a length that substantially extends in a radial direction of the tubular membrane. Preferably, these holes also extend substantially parallel to each other in a radial direction of the tubular membrane. This enables an effective filtration with this membrane layer. Preferably, the foamy asymmetrical layer is integrally formed as part of the polymer substrate layer during forming of the polymer substrate layer.

In a further preferred embodiment of the invention the nonwoven base layer has a weight between 60-120 g/m², preferably between 75-90 g/m², most preferably about 85 g/m².

It is shown that the nonwoven base layer provides sufficient strength and stability to the membrane with a relatively low weight. Preferably, the tubular membrane is self-supporting such that it is easy to handle and easy to use in practice. The nonwoven layer preferably comprises PET, PBT, PP, PE, PA, PAN or combinations thereof. Preferably, the nonwoven base layer has a thickness in the range of 50-200 μm, preferably in the range of 100-150 μm, and is most preferably about 120 μm. The thickness and weight of the nonwoven provides the required strength and stability to the membrane. The longitudinal weld contributes to effective membrane surface enhancement and enabling a limited thickness of the nonwoven layer such that resistance(s) are further reduced.

Furthermore, the nonwoven base layer has preferably an air permeability, measured at a pressure difference of around 200 Pa, in the range of 25-125 L/s/m², more preferably in the range of 40-100 L/s/m², and is most preferably about 85 L/s/m². The provided measurement concerns a standardized ISO-normed measurement conditions.

Especially the combination of the thickness, weight and air permeability of the nonwoven provides an effective tubular base layer. The inner diameter of the tubular membrane is preferably in the range of 3-8 mm, and is more preferably in the range of 5-7 mm most preferably about 5.5 mm.

In an embodiment according to the invention, the tubular membrane cross section can be circular shaped or oval shaped or may be mixture of circular and oval shaped. In a further preferred embodiment of the invention the longitudinal weld has a width in the range of 0.5-2 mm, more preferably in the range of 0.7-1.3 mm.

The invention further also relates to a device that is configured for forward osmosis and comprises a number of tubular membranes in an embodiment of the invention.

The device provides similar effects and advantages as described for the method and tubular membrane.

The invention further also relates to the use of a tubular membrane in an embodiment according to the invention in a forward osmosis process.

This use also provides similar effects and advantages as described for the method, tubular membrane and device. In particular, the tubular membrane can be advantageously applied to feed flows with a relatively high solid content. For example, the tubular membrane can be applied to milk flows.

Further advantages, features and details of the invention are elucidated on the basis of preferred embodiments thereof, wherein reference is made to the accompanying drawings, in which:

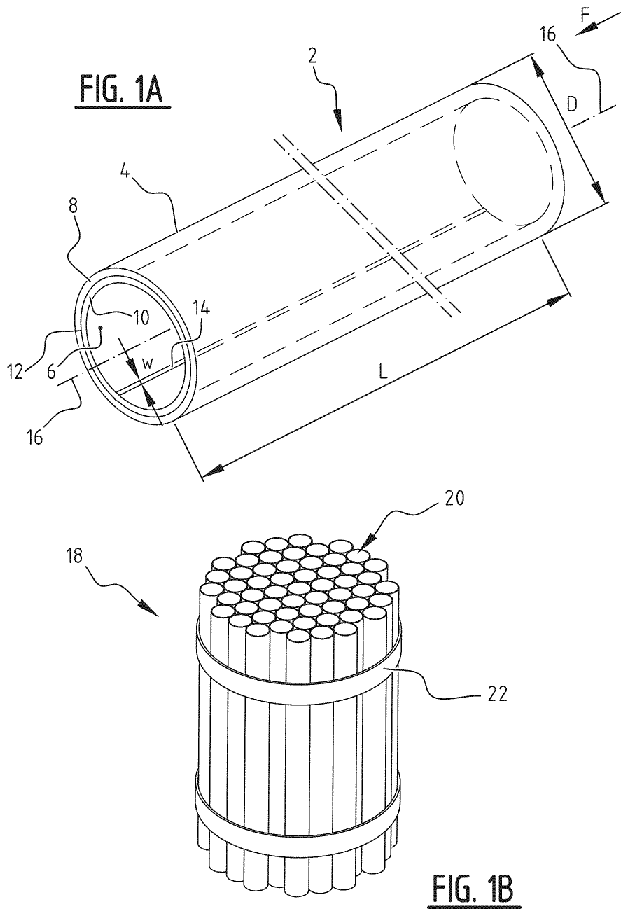

FIG. 1A schematically shows a tubular membrane in an embodiment of the invention;

FIG. 1B schematically shows a device with a number of tubular membranes illustrated in FIG. 1A;

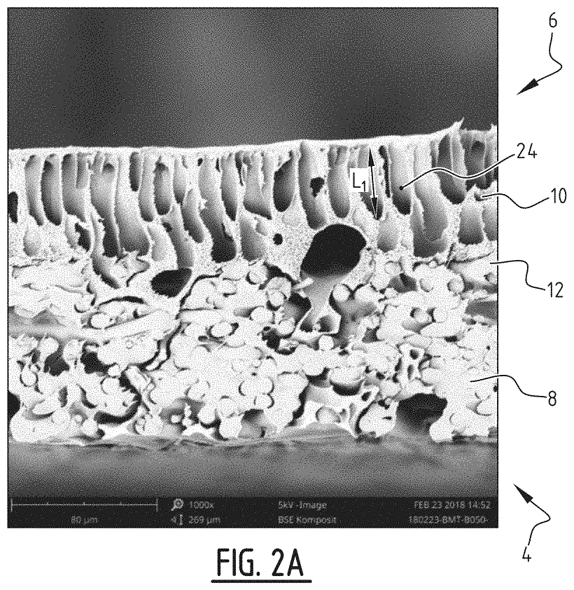

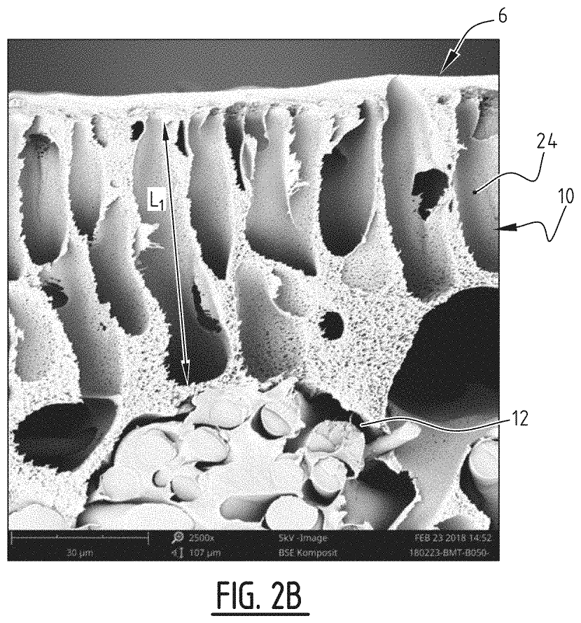

FIG. 2A shows a detailed and enlarged segment of the tubular membrane illustrated in FIG. 1A;

FIG. 2B shows a section of the wall segment of FIG. 2A;

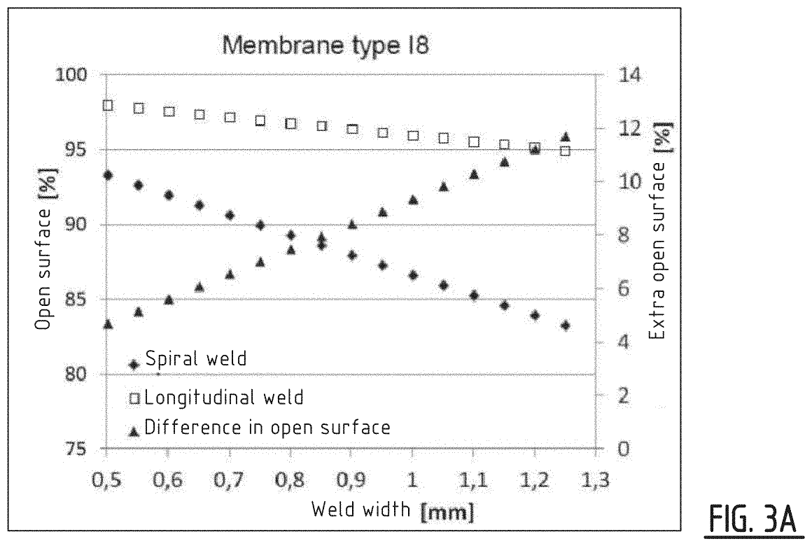

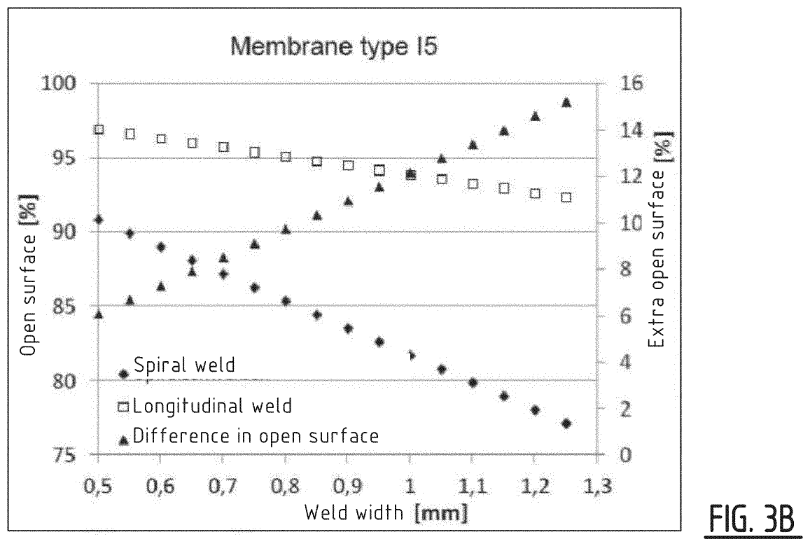

FIGS. 3A and B show properties of two types of membranes respectively membrane type I8 (FIG. 3A) and membrane type I5 (FIG. 3B);

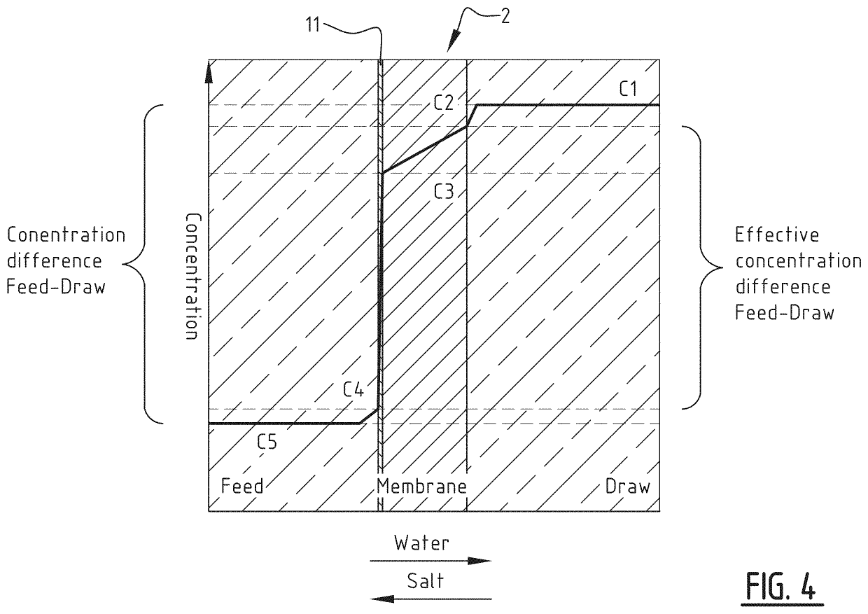

FIG. 4 shows a schematic overview of concentration gradient over the membrane; and

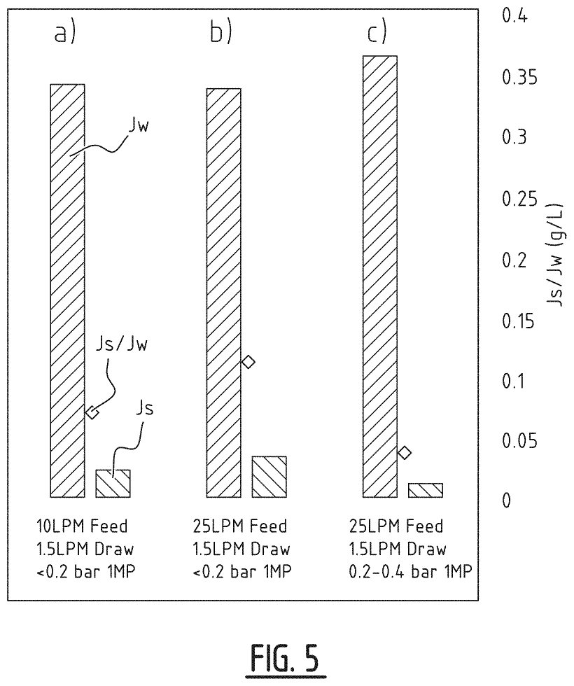

FIG. 5 shows some experimental results.

Tubular membrane 2 (FIG. 1A) has a length L, an inner diameter Dᵢₙ and an outer diameter Dₒᵤₜ. It is noted that the membrane diameter is preferably defined with respect to Dᵢₙ, even though it is possible to define the membrane diameter based on the outer diameter. Tubular membrane 2 has outer wall 4 and inner wall 6. Outer wall 4 is defined by outer layer 8 comprising a nonwoven material. Inner wall 6 is defined by polymer substrate layer 10 having the functional polymer layer 11 on top. The transition of nonwoven-substrate layer 12 is defined by the nonwoven region which is intruded with the polymer substrate layer 10. This transition region 12 enables attaching the substrate material to the nonwoven material. Longitudinal weld 14 has a width W and connects sides of nonwoven layer 8 to define the lumen of tubular membrane 2 along longitudinal axis 16. Feed flow F flows through the lumen in tubular membrane 2.

In the illustrated embodiment tubular membrane 2 has an inner diameter Dᵢₙ in the range of 5-6 mm, and width W is in the range of 0.7-1.3 mm.

Device 18 (FIG. 1B) comprises a bundle 20 of tubular membranes 2. A holder or housing 22 holds bundle 20 together such that the feed flow enters the lumen side of bundle 20 and draw flow enters the shell side of bundle 20. The feed flow and draw flow are solely in contact over the tubular membranes. It will be understood that device 18 is schematically illustrated. The skilled person could envisage different embodiments of bundle 20 in accordance to the invention.

On outer side 4 (FIG. 2A) nonwoven material 8 is very open as compared to substrate layer 10 that has a number of macrovoids 24. Macrovoids 24 have a length L₁ that substantially extends in a radial direction of the tubular membrane. It will be understood that the transition of nonwoven-substrate layer 12 between polymer substrate layer 10 and nonwoven base layer 8 can be irregularly shaped. Macrovoids 24 (FIG. 2B) substantially extend parallel to each other.

In the illustrated embodiment functional layer 11 is applied onto substrate layer 8 by interfacial polymerization. Commonly, the polymerization is a polycondensation reaction between two highly reactive monomers that are dissolved in two immiscible liquids which forms an ultrathin functional layer on top of the substrate layer. The separation of monomer pre-cursors in two phases results in the localized reaction at the interface and formation of a polymer layer. In the illustrated embodiment this formation occurs between 1,3-phenylene diamine (MPD) (in water) and trimesoyl chloride (TMC) (in hexane). The crosslinked network forms with the interchain-CONH-linkage between the aromatic rings.

In the following table a composition of the two liquids for obtaining functional layer 11 is represented.

TABLE
representation of the composition of the coating layer

| Reaction solution A | | Reaction solution B | |
|---|---|---|---|
| | Concentration | | Concentration |
| Component | (w/v-%) | Component | (w/v-%) |
| Water | | Hexan | |
| MPD (m- | 0.25-4 | TMC | 0.05-0.5 |
| Phenylendiamine) | | (Trimesoylchloride) | |
| SDS (sodium | 0.2-1 | | |
| dodecylsulfonate) | | | |
| CSA | 2-6 | | |
| (campher-10- | | | |
| sulfonic acid) | | | |
| TEA | 1-2 | | |
| (triethylamine) | | | |
| Glycerin | 5-20 | | |
| DMSO (dimethyl | | | |
| sulfoxide) | 0.5-2 | | |

It will be understood that many variations are possible in composition of the reactive system, i.e. variations in reactant A and reactant B, additives, solvents. Furthermore, the preparation conditions can be varied by many parameters as well: pre-treatment of the substrates, coating time, post treatment after each coating step, curing temperature and curing time amongst others.

Two membrane types have been compared relating to embodiments with longitudinal welds and spirally oriented welds, respectively. The two different membrane types also indicated by membrane type I8 (FIG. 3A) and membrane type I5 (FIG. 3B). Results show an increasing gain of membrane surface (▴) between the longitudinal weld (□) and the spiral weld (♦) embodiments. This effect increases with increasing welding width. In the illustrated embodiments the welding width increases from 0.5 to 1.3 mm.

Experiments have been performed with tubular membrane 2 in the ALFS mode (active layer facing feed side). In the experiments respective media on the feed-side and draw-side of the membrane are circulated. Water is transported through the membrane from the feed-side to the draw side and the feed-side becomes more concentrated while the draw-side becomes more diluted (FIG. 4). Highest concentration difference is in top layer 11. Also shown is the effective concentration gradient that is smaller than the concentration difference between feed flow and draw solution.

Experimental results (FIG. 5) are shown for:
a) 10 LPM (also defined as liters per minute or L/min) feed, 1.5 LPM draw and below 0.2 bar TMP;
b) 25 LPM feed, 1.5 LPM draw and below 0.2 bar TMP; and
c) 25 LPM feed, 1.5 LPM draw and 0.2-0.4 bar TMP.
   In the experiments nonwoven layer 8 of membrane 2 comprises polyester, a PES substrate layer and a lumen diameter of about 5 mm. The functional layer comprises aquaporin proteins formulated into a biomimetic matrix embedded on the surface by an immobilization matrix made by interfacial polymerization. The experiments were performed in an ALFS configuration. Further conditions were membrane area is 0.4 m², counter current configuration, draw solution concentration 1 M NaCl, duration 2-4 hrs. Water permeability of the substrate membrane is about 150-200 LMH measured at 1 bar. Results show a water flux Jw (LMH), salt flux Js (gMH) and ratio of Js/Jw. The experiments show the feasibility of using membranes according to the present invention in an FO process.

In addition, the following examples are provided to further support the present invention by providing aspects thereof as examples.

### EXAMPLE 1

The first example is directed to a method for producing a tubular membrane support, and more specifically a longitudinal welded membrane support. A longitudinal welded membrane support is in this example defined as the tubular base layer with a polymeric substrate layer.

In the example, polyester nonwoven that is used has the following specifications: weight: 85 g/m², thickness: 120 μm and air permeability measured at 200 Pa: 85 L/s/m². The nonwoven tube is formed by bending the nonwoven tape over a mandrel with an outer diameter of 5.5 mm and the overlap is fixed by means of ultrasonic welding in a continuous process. A polymer solution is coated continuously and in situ on the tubular nonwoven tube. The polymer solution contains polyethersulfone (PES) Ultrason 6020 (BASF) between 10-25 wt. % with polyvinylpyrrolidone PVP as pore forming additive in an aprotic solvent. Polymer solution is conveyed through the mandrel and leaves the system in the casting section. The polymer solution is brought onto the tube followed by doctoring to obtain a layer thickness of 0.1 mm Subsequently, the coated tube is conveyed through a cutting section where the coated tube is cut with a defined length dependent on module type. In a following step, the coated tube is transported in a precipitation bath containing RO-water (i.e. water prepared by reverse osmosis) with a temperature of 25° C., where the phase inversion process takes place and the membrane support is formed. The longitudinal welded membrane support is produced with a velocity between 7 and 10 m/min. The membrane support is rinsed with water for at least 16 hours. The membrane support is conditioned with 20% glycerin solution for at least 5 hours, followed by air-drying, followed by drying at 60° C. for more than 12 hours.

The membrane support has an inner diameter of approx. 5.3 mm and has a bursting pressure larger 8 bar. It is found that the pure water flux measured at 1 bar TMP under crossflow conditions is between 100-250 LMH. The retention of PEG 100k (polyethylene glycol with average My of 100,000 g/mol) measured with same conditions is >90%. The molecular weight cut-off measured with PEG-mixture is 5-15 kDa.

### EXAMPLE 2

The second example relates to a tubular membrane module, which in this example comprises a plurality of tubular membrane support as described in example 1. Each tubular membrane support has a membrane length of 1.1 times the module length. The plurality of tubular membrane supports, in this case comprising 118 membranes, is aligned parallel to each other for forming a membrane mat. Such a membrane mat is for example described in DE102016009914A1. DE102016009914A1 also discloses that the mat is rolled-up to a bundle. This bundle is inserted in a PVC module housing with a length of 125 cm and an outer diameter of 90 mm. The membrane bundle is fixed into the module housing by means an epoxy potting process. The epoxy block is approx. 3 cm thick. This results in an effective membrane length in the module of approx. 119 cm. The total membrane surface on the lumen side is approx. 2.3 m². The feed and retentate connections are 3 inch pipe grooves according to standard IPS PVC groove specifications and the shell side connections are ¾ inch female thread connections.

### EXAMPLE 3

The third example relates to a method for making a forward osmosis tubular membrane module.

In this example, a single-tube membrane module is provided, which module has a length of 50 cm and a lumen surface area of approx. 0.008 m². The module furthermore has a lumen inlet and a lumen outlet as well as a shell side inlet and a shell side outlet.

In a method step, the module is wetted in a glycerin-containing solution for at least 48 hours. Before the coating procedure starts, the module is emptied on the lumen side as well as on the shell side. The aqueous phase is prepared in advance and the composition of the aqueous phase contains following components with corresponding ratios:

RO-water:glycerine:isopropanol:m-phenylenediamine: 3,5-diaminobenzoic acid:camphor-10-sulfonic acid:trimethylamine:sodium dodecylsulfonate 100:10:0:1.5:1.5:6:1:1 (AqRec1)/100:10:4:1.5:1.5:6:1:1 (AqRec2)/100:10:6:1.5:1.5:6:1:1 (AqRec3).

The aqueous phase is conveyed bottom-up to fill the lumen side completely for 30 s, the lumen side is drained followed by top-down pressurized air flushing for 1 min with 1 Nm³/h followed by deadend pressurizing the tube with pressurized air at 0.5 bar for 1 min. After these steps, the pressure is released and the module is treated with the organic phase.

The organic phase, consisting of 0.15 wt % of trimesoylchloride in n-hexane, is conveyed bottom-up to fill the lumen side completely for 120 s, after which the lumen side is drained and followed by top-down pressurized air flushing for 1 min with 1 Nm³/h. Subsequently, this is followed by dead-end pressurizing the tube with pressurized air at 0.5 bar for 1 min. The pressure is than released and the module is heat-treated on as well as the lumen as the shell side with 80° C. hot pressurized air at module entrance with 2.1 Nm³/h for 15 min.

After the module is cooled down and subsequently the module is immersed in RO-water with ambient temperature. The membrane module can be measured in wet condition after at least 16 hours. Alternatively, the membrane module is dried with the membrane conditioning and drying process as described above.

Two modules per coating recipe were prepared using the method as described in this example. These modules were tested in counter-current, active layer facing feed solution configuration at ambient temperature with RO-water in the feed side and 1 M NaCl solution in RO-water on the draw side. The linear velocity on the lumen and shell side is 30 cm/s on both sides. The duration of the measurement was 90 minutes and the water flux and reverse salt flux were determined by averaging the data of the final 45 minutes of the measurement. This tests of the modules resulted in the following results:

| | AqRec1 | | AqRec2 | | AqRec3 | |
|---|---|---|---|---|---|---|
| Water flux (LMH) | 7.43 | 6.56 | 6.32 | 6.26 | 6.97 | 7.02 |
| Reverse salt flux (gMH) | 4.3 | 2.1 | 1.6 | 1.5 | 2.4 | 2.3 |

Results of test with modules of method according to example 3

### EXAMPLE 4

In the fourth example, an alternative procedure for manufacturing a forward osmosis tubular membrane module is provided. In this example, an alternative functional layer is provided to the module. The alternative functional layer is based on aquaporin containing thin film composites. The procedure of making these functional layers is similar to the procedure as described in example 3. Vesicle forming materials are added to the aqueous phase. Modules as described in example 2 have been coated by means of this formulation with their developed coating procedure by Aquaporin Asia Pte. Ltd. The tubular forward osmosis membrane modules with Aquaporin Inside® with a lumen surface area of approx. 2.3 m² are prepared and characterized.

The results of the membrane module with the alternative layer are provided below. It is noted that the modules were tested in co-current, active layer facing feed solution configuration at ambient temperature with RO-water in the feed side and 1 M NaCl solution in RO-water on the draw side. The linear velocity on the lumen and shell side are presented in the table below. The duration of the measurement is 2-4 h. The water flux and reverse salt flux are determined by averaging the data of the stationary part of the measurement. This tests of the modules resulted in the following results:

| | 1 | 2 | 3 | 4 | 5 |
|---|---|---|---|---|---|
| Linear flow velocity on: | | | | | |
| Feed side (cm/s) | 1.9 | 3.2 | 25.6 | 25.6 | 25.6 |
| Draw side (cm/s) | 0.6 | 0.6 | 0.6 | 5.6 | 11.2 |
| TMP (bar) | <0.2 | <0.2 | <0.2 | <0.2 | <0.2 |
| Water flux (LMH) | 3.81 | 4.13 | 5.05 | 5.78 | 6.16 |
| Reverse salt flux (gMH) | 0.14 | 0.05 | 0.25 | 0.38 | 0.37 |

Results of test with modules of method according to example 3

The tests have shown that the advantage of using TFC with Aquaporin Inside® is the high salt rejection of the membrane with sufficient water flux through the membrane.

The present invention is by no means limited to the above described preferred embodiments thereof. The rights sought are described by the following claims, within the scope of which many modifications can be envisaged.

1-16. (canceled)

17. A method for processing a fluid with forward osmosis process, the method comprising:
providing one or more tubular membranes, with the tubular membrane comprising:
a tubular base layer of a nonwoven material on the outside of the tubular membrane and forming an outer shell of the tubular membrane and providing a lumen for the feed flow;
a polymer substrate layer on the lumen-side of the tubular membrane comprising three regions, including a region where the polymer substrate layer is partially intruded into the tubular base layer, a region with an open macrovoid structure and a region with an asymmetrical foamy layer, wherein the partially intruded region forms an intermediate layer; and
a functional top layer on the polymer substrate layer;
wherein the tubular base layer comprises a longitudinal weld;
the method further comprising:
providing the feed flow through the lumen and providing a draw solution on the outer shell side of the tubular membrane; and
processing the feed flow with the membrane.

18. The method according to claim 17, further comprising cleaning the membrane in a cleaning step comprising a reversal of flows and/or an adjustable and/or settable crossflow velocity and/or an osmotic backwash.

19. The method according to claim 17, further comprising:
providing hydraulic pressure to the feed flow with a pressure in the range of 0-4 bar, wherein the hydraulic pressure on the feed side exceeds the pressure on the draw side.

20. A tubular membrane configured for forward osmosis processing, the tubular membrane comprising:
a tubular base layer of a nonwoven material on the outside of the tubular membrane and forming an outer shell of the tubular membrane and providing a lumen for the feed flow;
a polymer substrate layer on the lumen-side of the tubular membrane comprising three regions, including a region where the polymer substrate layer is partially intruded into the tubular base layer, a region with an open macrovoid structure and a region with an asymmetrical foamy layer, wherein the partially intruded region forms an intermediate layer; and
a functional top layer on the polymer substrate layer;
wherein the tubular base layer comprises a longitudinal weld.

21. The tubular membrane according to claim 20, wherein the functional polymer membrane layer comprises a polyamide-based layer on the polymer substrate layer.

22. The tubular membrane according to claim 20, wherein the foamy asymmetrical layer of the polymer substrate layer is integrally formed, and wherein the foamy asymmetrical layer is formed on top of the macrovoid-structured layer, wherein the macrovoid-structured layer is provided with a substantial amount of macrovoids, the macrovoids having a length that substantially extends in a radial direction of the tubular membrane.

23. The tubular membrane according to claim 20, wherein the tubular membrane is self-supporting.

24. The tubular membrane according to claim 20, wherein the nonwoven base layer has a weight between 60-120 g/m².

25. The tubular membrane according to claim 20, wherein the nonwoven base layer has a thickness in the range of 50-200 μm.

26. The tubular membrane according to claim 20, wherein the nonwoven base layer has an air permeability, measured at a pressure difference of around 200 Pa, in the range of 25-125 L/m²/s.

27. The tubular membrane according to claim 20, wherein the polymer substrate layer has a molecular weight cut off in the range of 5-20 kDa, wherein the molecular weight cut off is determined with filtration comprising polyethylene glycols.

28. The tubular membrane according to claim 20, wherein the longitudinal weld has a width in the range of 0.5-2 mm.

29. The tubular membrane according to claim 20, wherein the inner diameter of the tubular membrane is in the range of 3-8 mm.

30. The tubular membrane according to claim 20, wherein the tubular membrane cross section is circular shaped or oval shaped.

31. Device configured for forward osmosis process of feed flow, comprising a number of tubular membranes, wherein the tubular membrane comprises:
a tubular base layer of a nonwoven material on the outside of the tubular membrane and forming an outer shell of the tubular membrane and providing a lumen for the feed flow;
a polymer substrate layer on the lumen-side of the tubular membrane comprising three regions, including a region where the polymer substrate layer is partially intruded into the tubular base layer, a region with an open macrovoid structure and a region with an asymmetrical foamy layer, wherein the partially intruded region forms an intermediate layer; and
a functional top layer on the polymer substrate layer;
wherein the tubular base layer comprises a longitudinal weld.

32. The method according to claim 17, wherein the pressure is in the range of 0-2 bar.

33. The method according to claim 17, wherein the pressure is in the range of 0-1 bar.

34. The method according to claim 18, further comprising:
providing hydraulic pressure to the feed flow with a pressure in the range of 0-4 bar, wherein the hydraulic pressure on the feed side exceeds the pressure on the draw side.

35. The method according to claim 17, further comprising the step of forming the foamy asymmetrical layer of the polymer substrate layer, wherein the foamy asymmetrical layer is formed on top of the macrovoid-structured layer, wherein the macrovoid-structured layer is provided with a substantial amount of macrovoids, the macrovoids having a length that substantially extends in a radial direction of the tubular membrane, and wherein the functional polymer membrane layer comprises a polyamide-based layer on the polymer substrate layer.
